(19) United States
(12) Patent Application Publication
(10) Pub. No.: US 2014/0330600 A1
(43) Pub. Date: Nov. 6, 2014

(54) Performance Driven Municipal Asset Needs and Sustainability Analysis

(71) Applicant: International Business Machines Corporation, Armonk, NY (US)

(72) Inventors: Mehmet F. Candas, Croton On Hudson, NY (US); Arun Hampapur, Norwalk, CT (US); Tarun Kumar, Mohegan Lake, NY (US); Shilpa N. Mahatma, Mohegan Lake, NY (US); Chandrasekhara K. Reddy, Kinnelon, NJ (US)

(73) Assignee: International Business Machines Corporation, Armonk, NY (US)

(21) Appl. No.: 13/967,431

(22) Filed: Aug. 15, 2013

Related U.S. Application Data
(63) Continuation of application No. 13/874,615, filed on May 1, 2013.

(51) Int. Cl. G06Q 10/06

(52) U.S. Cl. CPC G06Q 10/0631
USPC 705/7.12

(57) ABSTRACT

Embodiments of the invention relate to a method for providing performance driven municipal asset needs and sustainability analysis. The method includes calculating asset health scores for a plurality of assets in an infrastructure. The asset health scores change as a function of time. The method also includes identifying prescription options for the assets. The identifying is based on the asset health scores. The prescription options include cost, value, and time for execution. A multi-objective optimization is applied based on the asset health scores and prescription options to identify at least a subset of the prescription options that may be implemented within a provided budget to maintain a sustainability threshold for an overall infrastructure health score.

### CROSS-REFERENCE TO RELATED APPLICATION

This application is a continuation of U.S. patent application Ser. No. 13/874,615, filed May 1, 2013, the content of which is incorporated by reference herein in its entirety

### BACKGROUND

The present invention relates generally to asset management, and more specifically, to performance driven municipal asset needs and sustainability analysis.

A typical city has many infrastructures such as gutters, sewers, telephone cables, television cables, electricity cables, gas lines, water, roadways, and sidewalks. Assets in the water infrastructure alone include pipes, valves, joints, hydrants, meters, main lines, service connections, etc. At present, no common methodology exists for determining the current health index of an asset. The health assessment of an asset is often a subject matter expert (SME) defined measurement of the performance of the asset. Being able to identify the right prescription option (e.g., a suggested action to be taken to maintain an asset) is important to overall municipal planning. Due to the sheer number of assets being maintained by a typical municipality, it is not practical to perform this process manually. In addition, the inability to apply a unified methodology hinders the identification of a correct health index which in turn prevents the association of the right prescription at right time. Given budget shortfalls, cities need to identify budget gaps to understand the implications of different prescriptions on the sustainability of an asset. Currently, cities generally rely on the knowledge of the city workers to identify the current and future needs for asset maintenance. This is often done using a sampling approach and it does not provide consistency across city assets.

### BRIEF SUMMARY

An embodiment is a method, computer program product, and system for providing asset management. The method includes calculating asset health scores for a plurality of assets in an infrastructure. The asset health scores change as a function of time. The method also includes identifying prescription options for the assets. The identifying is based on the asset health scores. The prescription options include cost, value, and time for execution. A multi-objective optimization is applied based on the asset health scores and prescription options to identify at least a subset of the prescription options that may be implemented within a provided budget to maintain a sustainability threshold for an overall infrastructure health score.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts an overview of a process for performing municipal asset needs and sustainability analysis in accordance with an embodiment;

FIG. 2 depicts a process for performing municipal asset needs and sustainability analysis in accordance with an embodiment;

FIG. 3 depicts an illustration of a degradation table and graph in accordance with an embodiment;

FIG. 4 depicts logic for performing sustainability analysis in accordance with an embodiment;

FIG. 5 depicts a user interface of a web browser of a municipal asset management tool in accordance with an embodiment;

FIG. 6 depicts a user interface of a web browser for depicting a distribution of prescription options by time and total cost in accordance with an embodiment;

FIG. 7 depicts a user interface of a web browser for depicting a budget amount needed for keeping an age of an asset in a selected range in accordance with an embodiment;

FIG. 8 depicts a user interface of a web browser for providing comparing municipal asset management in accordance with an embodiment; and

FIG. 9 depicts a computer system for providing municipal asset management in accordance with an embodiment.

### DETAILED DESCRIPTION

Embodiments described herein provide a unified approach to computing a health index of a group of assets (e.g., city assets such as, but not limited to roads, signs, trees, water networks, sewers, treatment plants, and buildings). Assets may be characterized as above ground (e.g., roads, signs), below ground (e.g., sewer pipes) or a combination of both above and below ground (e.g., electrical cables). In addition, assets may be characterized as linear (e.g., roads) or point (e.g., sewer cover). The unified approach described herein is flexible in order to allow a subject matter expert (SME) to apply the right business drivers and data driven factors to compute the health index of the assets. Embodiments also apply asset specific prescriptions to generate an optimal allocation of prescriptions for each asset based on a calculated health index. Embodiments described herein are also used to perform long term sustainability analysis given funding constraints, asset degradation, and time dependent prescription options.

As described herein, embodiments are utilized to analyze key performance indicators (KPIs) to assign a health index score and to identify potential prescription options. This analysis may be performed by calculating a unified health index using predictive and historical KPI values in an analytical framework. An embodiment of the analysis treats each asset separately. Outputs may include a temporal view of prescriptions, cost, service life extensions, and service level improvement. The types of analytics used may include predictive analytics and an analytic framework.

As used herein, the terms “health index” and “health assessment” are used interchangeably to refer to a defined measurement of the performance of an asset. This measurement may be defined by a SME. In an embodiment, an asset health index score is calculated based on business drivers, asset factors, and degradation. In an embodiment, degradation is used to calculate asset factor values by time and may be determined using a piecewise linear function that defines the cumulative change in an asset factor (e.g., a paving quality indicator (PQI)).

As used herein, the term “business driver” refers to an organization's KPIs or core focal area for evaluating, computing and reporting on a business metric. The business driver could also take a form of a defined program. Business drivers may include, but are not limited to: asset condition, risk, conformance to standard, capacity, and expected increase in use of asset. Each business driver in a group of business drivers for a particular asset or asset class may be assigned a weight to indicate its relative importance in assessing the health of the asset.

As used herein, the terms “asset factor” and “data driven factor” are used interchangeably to refer to specific qualitative or quantitative factors that are used to compute the health of an asset. Asset factors are defined for each asset and the data is collected by the organization. For example, in a road network, asset factor values generally correspond to each section of the road (i.e., between two intersections). Asset factors may include, but are not limited to: asset age, number of breaks, and material.

In an embodiment, where the assets are roads, or streets, one of the business drivers may be capacity. The business driver capacity may then be related to asset factors such as, but not limited to: average daily traffic, width of road, and type of road (highway, rural, etc.). In an embodiment, business drivers for a class of assets (e.g., roads, pipes) are identified and then asset factors are selected for each of the identified business drivers.

As used herein, the term “prescription” refers to an action to be taken (it also includes taking no action) to maintain (also includes repairing) an asset.

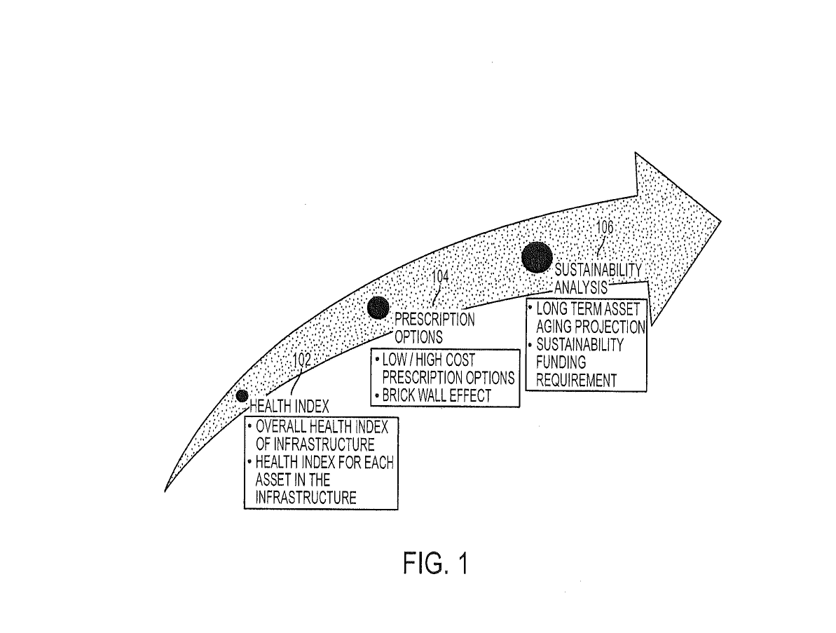

Turning now to FIG. 1, an overview of a process for performing municipal asset needs and sustainability analysis in accordance with an embodiment is generally shown. A health index 102 that includes an overall health index of an infrastructure (e.g., gutters, sewers, telephone cables, television cables, electricity cables, gas lines, water lines, roadway surfaces, sidewalks, and the like) and a health index for each asset in the infrastructure may be generated by an embodiment. Generating the health index 102 may include: defining key performance drivers (or KPIs) for asset classes; using data driven factors to associate performance drivers and assign weights; computing asset health scores based on performance drivers and factor scores; and using degradation curves to identify asset health for future years (e.g., the next five, ten and thirty years).

Prescription options 104 as shown in FIG. 1 include low/high cost prescription options and a brick wall effect (e.g., the point in time at which the asset will likely need a major repair if a smaller repair is not performed at an earlier point in time). For example, in a road infrastructure, prescription options may include tar and chip sealing, 50 millimeter (mm) overlay, 100 mm overlay, pave and pulverize, and full depth reconstruction. In a water or waste water infrastructure, prescription options may include cured in-place pipe (CIPP) lining, cement-mortar lining, and replacement. The costs of prescription options may be expressed in terms of unit length. Prescription option costs multiplied by an actual length of the asset results in a total prescription cost. Costs of prescriptions increase from lower cost prescriptions such as tar and chip sealing to more expensive prescriptions such as full depth reconstruction. Similarly, the value of a prescription when measured in terms of an increase in asset life in accordance with an embodiment may change from two years for tar and chip sealing to fifty years for full depth construction. Additionally, the value of a prescription when measured in terms of a qualitative improvement (e.g., for roads, quality is a measure of driving comfort) in accordance with an embodiment may vary from ten percent for tar and chip sealing to one-hundred percent for full depth reconstruction.

In accordance with an embodiment, generating the prescription options 104 may include: applying suggested treatment options on the assets using the driver scores; given the asset health scores, treatment options, and the expected future budget, identifying projects (e.g., capital, and operations and management (O&M)) that will impact and improve the drivers such as growth, capacity, risk, and compliance; determining what treatment options can be done, when they can be done, and how much they will cost; and assigning an expected time for executing a project.

Sustainability analysis 106 as shown in FIG. 1 that includes long term asset aging projection and sustainability funding requirements may be generated by an embodiment. Performing the sustainability analysis 106 may include: looking out a number of years (e.g., ten, thirty, one hundred) to identify the city needs, expected O&M outlay, and capital investment needed to maintain and/or improve the current performance of the assets; determining whether a rate case can be made today that will help offset a big bump in future performance degradation.

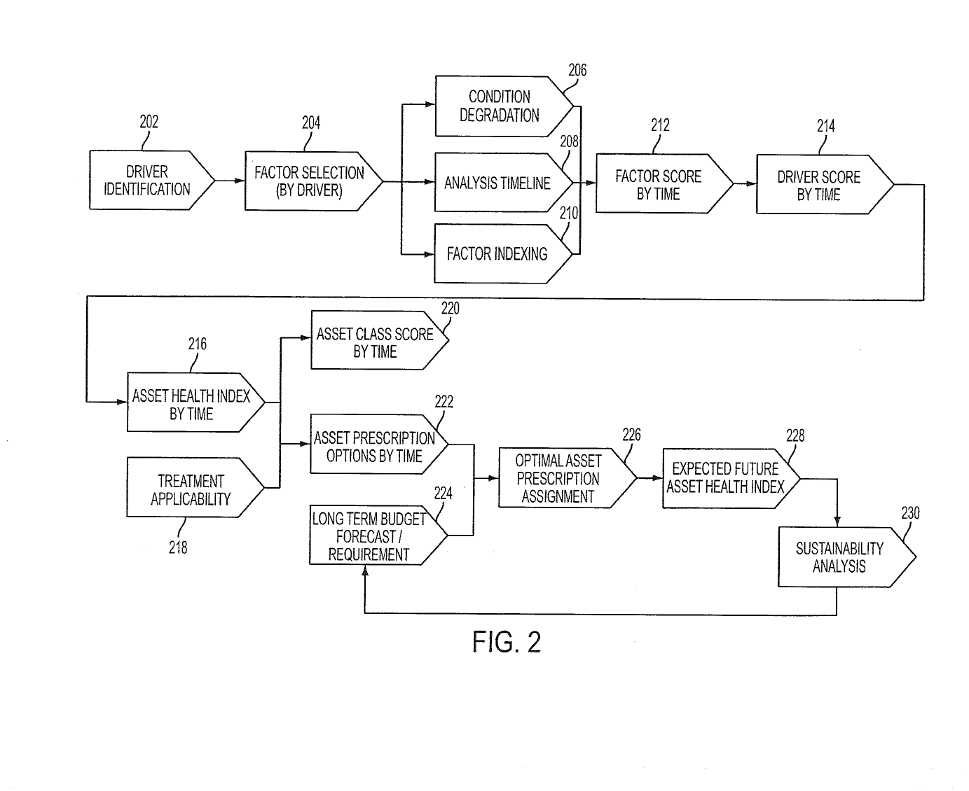

Turning now to FIG. 2, a process for performing municipal asset needs and sustainability analysis for a class of assets in accordance with an embodiment is generally shown. In an embodiment, the data described in blocks 202-210, 218 and 224 may be input and/or selected from a list by a user (e.g., a SME) via a user interface in provided by municipal asset management tool (e.g., software) executing on a processor. The data may also be received and/or requested from another computer system or computer storage location (e.g., a database).

In an embodiment, an asset management database may store one or more asset factors (AFs) for an asset that describes asset factor details such as the age of an asset, a material of the asset, etc. Specific data fields may include an asset identifier (e.g., an unique asset identification number), a factor (e.g., a condition index, material, age), and a factor value (e.g., current asset factor value).

At block 202, business drivers associated with the asset, such as, but not limited to condition, risk, conformance to standards, and capacity, are identified. For example, if the asset is a roadway, then the business drivers may include condition and risk of the road. In an embodiment, an asset management database may store one or more asset drivers (ADs) that are mapped to an asset class. Specific data fields may include a scenario identifier (e.g., a unique identifier for an execution scenario which is used for multi-scenario analysis), a driver (e.g., drivers such as condition, capacity, risk), a driver weight (e.g., a weight of the specific driver defined for the asset class at that scenario, and a sum of the weights by drivers should add up to 100% such as condition 50%, capacity 30% and risk 20%).

At block 204, asset factors are selected for business drivers input at block 204. Using the example where the asset is a roadway and the business driver is condition, asset factors (also referred to as driver factors or “DFs”) may include a pavement quality index (PQI) (e.g., on a scale of 0 to 10) and an age of the roadway. In an embodiment, an asset management database may store one or more DFs that are mapped to business driver. Specific data fields may include a scenario identifier (e.g., a unique identifier for an execution scenario which is used for multi-scenario analysis), a driver (e.g., drivers such as condition, capacity, risk), a factor (e.g., age, material, quality index), and a factor weight. The factor weight may be the weight of the specific factor defined under a specific business driver. The sum of the weights of factors under each business driver should add up to 100%. For example, if condition is the driver, the factor weights may include age 40% and PQI 60%.

Condition degradation information for the asset is input at block 206 to account for the condition of the asset deteriorating over time. In the example where the asset is a roadway, the business driver is condition, and the asset factor is PQI, the degradation information may be that the rating of the PQI decreases by a half a point on the scale in every year that no maintenance is performed on the road. In an embodiment, an asset management database may store data about degradation (D) that includes cumulative asset factor degradation by asset age. Data about degradation may be sourced from historical data related to the asset type and/or materials used in the asset.

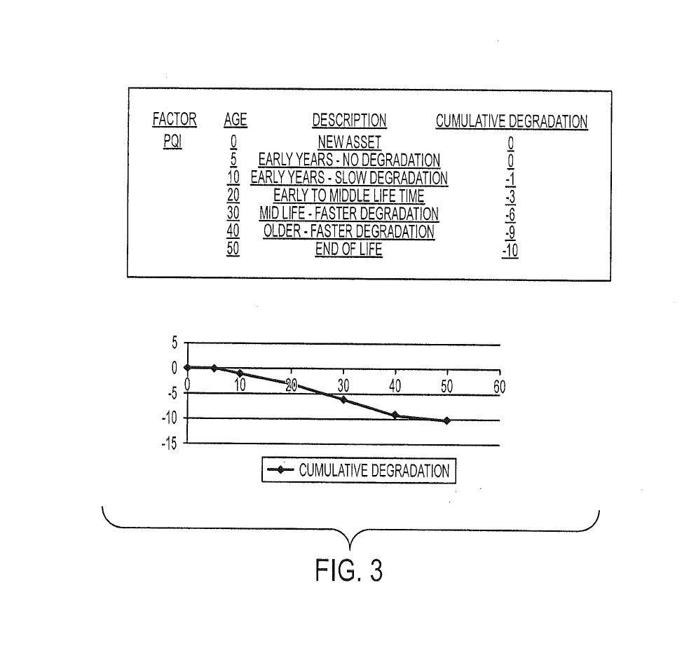

Turning now to FIG. 3, an illustration of a degradation table and curve for PQI is generally shown in accordance with an embodiment. As shown in FIG. 3, this information may be represented as a table and/or as a graph. The graph in FIG. 3 illustrates a degradation curve for PQI and includes a piecewise linear function capturing the cumulative change of the factor value by age (time). For the example shown in FIG. 3, the PQI of a new asset is equal to ten and the end of life PQI is equal to zero (PQI of new asset plus cumulative degradation at age fifty). Specific data fields for degradation (D) may include a scenario identifier (e.g., a unique identifier for an execution scenario which is used for multi-scenario analysis), a factor (e.g., age, material, quality index), an age (e.g., asset age by time), a description (e.g., a description for the degradation at that age), and a cumulative degradation (e.g., a cumulative degradation value which could be a negative such as pavement quality index decreasing by time or a positive such as a number of failures increasing by time). Referring back to FIG. 2, the analysis timeline for the asset (e.g., five years, ten years, twenty years) is input at block 208.

At block 210, factoring indexing is input to describe to the model how the model should interpret the asset factors. For example, for the asset factor of age, the factor indexing input may indicate that a roadway with an age of zero should result in a higher health index than a roadway with an age of ten. In an embodiment, an asset management database may store one or more factor indexes (FIs). In an embodiment, a factor score is stored for each factor value segment. The factor value may be segmented in a variety of manners, including, but not limited to: (1) range (such as “if from_range<age<to_range” then “factor score=index_value”); (2) discrete segmentation (such as “if number_of_breaks=int_value”, then “factor score=index_value”); and (3) string comparison (such as “if material of pipe=string_value” then “factor score=index_value”). Specific data fields for a factor index (FI) may include a scenario identifier (e.g., a unique identifier for an execution scenario which is used for multi-scenario analysis), a driver (e.g., drivers such as condition, capacity, risk), a factor (e.g., factors such as age, material, quality index), an index type (e.g., type of segmentation such as range, integer (discrete), string), a from range (e.g., a lower bound of the range which is used in range segmentation of the factor), to range (e.g., upper bound of the range which is used in range segmentation of the factor), integer value (e.g., integer value used for discrete segmentation of the factor), string value (e.g., string value used for string segmentation of the factor), and index value (e.g., resulting factor score for the mapped segment).

Referring to block 212 of FIG. 2, the municipal asset management tool generates a score for each asset factor over time (after five years, after ten years, etc.). In an embodiment, the time periods are based on the analysis timeline input at block 208. In an embodiment, the factor score by time generated at block 212 is based on data input at blocks 206, 208, and 210. The factor score by time shows the value of asset health for each of the factors and each individual asset segment/section as a function of time. For example, given PQI as a factor, the score for each asset would show the health assessment value for each time period. The score would change if the PQI has degradation over time.

An embodiment of the municipal asset management tool calculates the factor score by time at block 212 as shown below. Factors are categorized into two groups while calculating the factor scores by time. Group 1 includes factors that are not degrading by time, such as material of the pipe, road class, being truck road or not and so on. For this group (Group 1) factor value (hence the factor score) is static over time. Group 2 includes factors that are degrading by time, such as pavement quality index (see FIG. 3), number of pipe failures, number of potholes, and so on. For this group (Group 2) factor value (hence the factor score) is dynamic over time. For Group 1, the factor score is calculated for the current year, and the same factor score is used for the future years. For Group 2, the factor score is calculated for each year by using degrading factor values.

Listed below is pseudo code of an algorithm (Algorithm 1) for an embodiment of the factor score by time calculation. Lines 1-15 iterate through all assets, drivers, and factors defined for that asset class. Lines 2-8 calculate asset factor score by time for the non-degrading factors. In the first for loop at lines 3-5, factor score is calculated for the current year. And in the second for loop at lines 6-7, the same factor score is assigned for to future years. Lines 9-14 calculate asset factor score by time for the degrading factors. One of the inputs includes a “degraded_factor_value_{a,t}” which is calculated by applying the degradation curve to the asset factor value. At line 16, non-degrading and degrading factor scores are combined.

Algorithm 1

| | |
|---|---|
| 1 | For (a ∈ Asset_Id) and (d ∈ ST_Asset_Driver) and (f ∈ |
| | ST_Asset_Factor) { |

| | |
|---|---|
| 2 | If (f is non-degrading) { |

| | |
|---|---|
| 3 | For all (fi ∈ ST_Factor_Index_{d,f}) |

| | |
|---|---|
| 4 | If (fi.From_Range ≦ f.factor_valueₐ < fi.To_Range) |

| | |
|---|---|
| 5 | Factor_Score_Static_{a,d,f} = fi.Index_Value |

| | |
|---|---|
| 6 | For all (t ∈ Planning _Horizion) |

| | |
|---|---|
| 7 | Factor_Score_Non-Degrading_{a,d,f,t} = |
| | Factor_Score_Static_{a,d,f} |

| | |
|---|---|
| 8 | } |
| 9 | Else |
| 10 | For (t ∈ Planning_Horizion) |

| | |
|---|---|
| 11 | For (fi ∈ ST_Factor_Index_{d,f}) |

| | |
|---|---|
| 12 | If (fi.From_Range ≦ f.degraded_factor_value_{a, t} < |
| | fi.To_Range) |

| | |
|---|---|
| 13 | Factor_Score_Degrading_{a,d,f,t} = fi.Index_Value |

| | |
|---|---|
| 14 | } |

| | |
|---|---|
| 15 | } |
| 16 | Factor_Score_{a,d,f,t} = Factor_Score_Non-Degrading_{a,d,f,t} ∪ |
| | Factor_Score_Degrading_{a,d,f,t} |

Referring now to FIG. 2 at block 214, a driver score by time is computed by the municipal asset management tool based on the factor scores by time received from block 212. In an embodiment, the driver score by time includes a value of asset score for each of the business drivers (e.g., capacity, compliance, risk, conformance to the standard) and each individual asset segment/section. The driver scores may be computed using the weighted sum of asset factors for each time intervals. An embodiment of the municipal asset management tool calculates the driver score by time as shown below.

Driver score by time may be calculated by getting the weighted average (factor weights) of the factor scores by time, as:

$${Driver\_Score}_{a , d , t} = \frac{{Σ}_{f ∈ {DF}_{d}} f . factor\_weight * {Factor\_Score}_{a , d , f , t}}{{Σ}_{f ∈ {DF}_{d}} f . factor\_weight}$$

At block 216, the municipal asset management tool generates a health index, or health assessment, for the asset over time that is based on the driver score by time generated at block 214. The asset health index by time shows the overall asset score for each individual asset segment/section as a function of time. Asset scores for each asset is the weighted sum over all business drivers. In an embodiment, the asset health index by time is calculated as shown below.

Asset health index by time may be calculated by getting the weighted average (driver weights) of the driver scores by time, as:

$$Asset\_Health {\_Index}_{a , t} = \frac{{Σ}_{d ∈ {AD}_{a}} d . driver\_weight * {Driver\_Score}_{a , d , t}}{{Σ}_{d ∈ {AD}_{a}} d . driver\_weight}$$

Turning now to block 218 of FIG. 2, treatment applicability is input for use by the model in determining when particular treatments should take place. For example, the treatment applicability may specify to the model to wait to repave a section of the roadway until after a scheduled replacing of a pipe in the roadway is completed. In an embodiment, an asset management database may store one or more asset treatment (AT) details which are defined for an asset class. Specific data fields may include a scenario identifier (e.g., a unique identifier for an execution scenario which is used for multi-scenario analysis), a treatment (treatment options, e.g., for a road may include 50 mm overlay, crack sealing, full replacement, tar and chip seal, etc.), unit (unit of treatment such as meter for pipe replacement or meter squared for pavement), unit cost (cost for unit treatment), service life extension (quantitative, for example, service life extension in years if treatment option is applied), service level improvement (qualitative, for example, service level improvement in percentage if treatment is applied). In an embodiment, both service life and service level are tracked because some treatment options (e.g., crack sealing) may improve service life but not service level.

At block 220 in FIG. 2, an asset class score by time is generated. As used herein, the term “asset class” refers to a grouping by type of asset. For example, in municipalities, asset classes may include, but are not limited to, road, water, storm, and sewer. In the gas industry asset classes may include, but are not limited to, gas, pipes, and compressor stations. In the electric distribution industry asset classes may include, but are not limited to, distribution transformers, cables, circuits, and poles. In an embodiment, the asset class score represents one number for each time interval for each asset class. This the weighted sum of all assets in an asset class as a function of their length. An embodiment of the municipal asset management tool calculates the asset class score by time as shown below.

Asset class score by time may be calculated by getting the weighted average (asset quantity) of the asset health index by time, as:

$$Asset\_Class {\_Score}_{t} = \frac{{Σ}_{a ∈ Asset\_Id} a . Asset\_Quantity * Asset\_Heath {\_Index}_{a , t}}{{Σ}_{a ∈ Asset\_Id} a . Asset\_Quantity}$$

At block 222, asset prescription options by time are generated to provide prescription options for each individual asset segment/section as a function of time. These prescription options may change over time if the asset health changes. For example, if a road health is measured on a scale of 0-100 [0—worst condition 100—new road] and a road gets a score of 80 in the first year, it may become a candidate for tar and chip sealing at a cost of $10,000. In 5 years, the asset health score of the road may change to 50, in which case tar and chip sealing do not apply anymore, and instead the road becomes a candidate for a 100 mm overlay costing $50,000. An embodiment of the municipal asset management tool calculates the asset prescription options by time as shown below.

In an embodiment, the asset management database may store one or more driver score treatments (DSTs) which map assets to treatments based on driver score values. In an embodiment, the DSTs are stored in a table. Specific data fields may include a scenario identifier (e.g., a unique identifier for an execution scenario which is used for multi-scenario analysis), a treatment (treatment options, e.g., for a road may include 50 mm overlay, crack sealing, full replacement, tar and chip seal, etc.), a driver (drivers such as condition, capacity, risk, etc.), from range (a lower bound of the range for the driver score value where the treatment option should be applied), to range (an upper bound of the range for the driver score value where the treatment option should be applied).

In addition, the asset management database may store a treatment filter that identifies exclusions for the treatment options for specific conditions based on asset factor values.

Asset prescription options by time may be calculated by iterating through asset driver scores and comparing these score with the ranges defined in the DST table as shown in the algorithm below (Algorithm 2). As shown in an embodiment of the pseudo below which may be used to implement Algorithm 2, if asset driver score at time t, is in between the range for that treatment option (p), than treatment p is added to the list of treatments for that asset at time t.

Algorithm 2

For (a ∈ Asset_Id) and (d ∈ ST_Asset_Driver) {

If (DST.From_Range_{d,p} ≦ Driver_Score_{a,d,t} < DST.To_Range_{d,p}) {

Asset_Prescription_Options = Asset_Prescription_Options ∪
(a,t,p)

}

}

Turning now to block 224 of FIG. 2, long term budget forecasts and requirements are input. Both the asset prescription by time generated at block 222 and the long term budget forecasts and requirements are input to block 226. At block 226 an optimal asset prescription assignment is generated to provide insight into how the potential prescriptions can be assigned for each planning year based on the budget availability. Given multiple prescription options, an embodiment of the mathematical model picks the optimal prescription over the analysis time horizon (e.g., using an optimization model). It may also compute the amount of backlog for each year, providing visibility into unfunded future needs. For each year, the mathematical model may compute the new age of each individual asset segment/section and overall weighted age of the asset class. An embodiment of the municipal asset management tool calculates the optimal asset prescription assignment as shown below.

At block 228, an expected future asset health index is generated to provide insight into how the prescription options impact and influence the asset health. For example, if a tar and chip seal is performed on an asset having a score of 80, the new expected score changes to 90 and the new age of asset changes from 5 years to 3 years. By applying treatment options from the sustainability analysis optimization results, the expected asset health scores may be recalculated. In an embodiment, at block 228, the expected factor/driver/asset/asset class scores for the future are recalculated (using the same factor, driver, asset, asset health score calculations from before) given that the sustainability analysis results are applied (i.e., results from block 226 are applied).

At block 230, a sustainability analysis is performed to provide insight into whether the budget contains enough money to perform selected prescriptions such that the average age of the infrastructure does not increase (or it is kept in desired level). An increase in the average age of the infrastructure may indicate that the investment/budget is not enough to keep the infrastructure sustainable. Having an infrastructure that is not sustainable may result in an increase in failures and condition deterioration. In an embodiment, at block 230, the expected scores from block 228 are analyzed to see if the assets are aging or not (e.g., whether conditions are getting better or not). Then, based on this analysis, it is determined either that the budget is sustainable, or the budget is redone (as in block 224) and the sustainability re-analyzed at block 226.

Example additional datasets for sustainability analysis in accordance with an embodiment are provided in Table 1.

TABLE 1
Input Data Sets

| Set Name-Set Short Name | Set Fields | Description |
|---|---|---|
| ST_Asset_Prescription_Options - P | | Asset prescription options and |
| | | details, which are generated by |
| | | Algorithm 2 |
| | Scenario_Id | Execution scenario id |
| | Asset_Id | Unique identified for the |
| | | individual asset (road segment id |
| | | for the road asset, or pipe segment |
| | | id for the water pipe). |
| | Driver | Drivers, such as condition, |
| | | capacity, risk and so on |
| | Treatment | Identified treatment options, such |
| | | as for road: 50 mm overlay, crack |
| | | sealing, full replacement, tar an |
| | | chip seal and so on |
| | Treatment_Cost | Total cost of treatment when it is |
| | | applied to the individual assets |
| | | (calculated by |
| | | ST_Asset_X_Treatment.unit_cost |
| | | multiplied by the asset quantity). |
| | SLE | (Quantitative) Service life |
| | | extension (years) if treatment |
| | | option is applied |
| | SLI | (Qualitative) Service level |
| | | improvement (percentage) if |
| | | treatment is applied. Some |
| | | treatment options may improve |
| | | service life, but not service level, |
| | | such as crack sealing. |
| | Time | Year that asset requires the |
| | | specific treatment |
| ST_Budget_Percentage - BP | Scenario_Id | Execution scenario id |
| | Time | Year that asset requires the |
| | | specific treatment |
| | Treatment | Identified treatment options, such |
| | | as for road: 50 mm overlay, crack |
| | | sealing, full replacement, tar an |
| | | chip seal and so on |
| | Percentage | Percentage value, that will be used |
| | | to limit budget spent to certain |
| | | treatment type |
| | Direction | Direction of the percentage limit |
| | | to be applied, such as “at_most”, |
| | | or “at_least” |
| ST_Budget - B | Scenario_Id | Execution scenario id |
| | Time | Year that asset requires the |
| | | specific treatment |
| | Budget | Total available budget at year t |
| ST_Target_Age - TA | Scenario_Id | Execution scenario id |
| | Time | Year that asset requires the |
| | | specific treatment |
| | Target_Age | Target average asset age by time |
| | | that is desired to be achieved |
| ST_Execution_Objective - EO | Scenario_Id | Execution scenario id |
| | Objective_Id | Unique identifier for the different |
| | | objectives of planning, such as |
| | | “minimize the average asset age |
| | | by given budget”, or “minimize |
| | | the required budget (addition) to |
| | | achieve the target age” |
| S_Planning_Horizon - T | | Planning years (defined as an |
| | | execution parameter, such that, |
| | | user can plan for desired time |
| | | horizon) |
| S_Asset_Id - A | | Set of unique asset ids in the |
| | | planning (calculated from |
| | | p.Asset_Id) |
| P_Asset_Age_{a ,} ∀a [symbol] A | | Current age of the assets |
| P_Asset_Quantity_{a ,} ∀a [symbol] A | | Quantity of the asset (such as |
| | | length of water pipe, or area of the |
| | | road) |

Decision variables used by an embodiment of the sustainability analysis performed at block 226 may include: V_APₚ, ∀pεP (binary (0,1) decision variables indexed over ST_Asset_Prescription_Options, gets a value 1 if the treatment p is selected at given time (p.time), and 0 otherwise), V_BudgetOverageₜ, ∀tεT (decision variables indexed over S_Planning_Horizon, captures the slack budget that is needed to fund the required treatments), and V_AvgAssetAgeExcessₜ, ∀tεT (decision variables indexed over S_Planning_Horizon, captures the excess average asset age above the desired target average asset age).

A sustainability analysis optimization model that may be implemented by an embodiment of the municipal asset management tool follows.

$$\begin{matrix}Maximize : \\ P\_Obj 1 \_Selected * Obj 1 \_SLE & 1.1 \\ P\_Obj 2 \_Selected * {w}_{1} * Obj 2 \_AvgAssetAgeExcess & 1.2 \\ P\_Obj 2 \_Selected * {w}_{2} * Obj 2 \_MaxBudgetOverage & 1.3 \\ P\_Obj 2 \_Selected * {w}_{3} * Obj 2 \_BudgetOverage & 1.4 \\ P\_Obj 2 \_Selected * {w}_{4} * Obj 2 \_BudgetSpending & 1.5 \\ Subject to constraints : \\ DE\_AssetAge {\underline{a}}_{/ , t} = max l ( 0 , ( \begin{matrix}( {P\_AssetAge}_{a} + t - CurrentYear ) - \\ {\sum }_{{p ∈ P :}_{{p . Asset\_Id = a ,}_{t > p . Time}}} p . SLE * {V\_AP}_{p}\end{matrix} ) ) , \\ ∀ a ∈ A , t ∈ T & 2 \\ {DE\_AvgAssetAge}_{t} = \frac{( {Σ}_{a ∈ A} P\_Asset {\_Quantity}_{a} * DE\_Asset {\_Age}_{a , t} )}{( {Σ}_{a ∈ A} P\_Asset {\_Quantity}_{a} )} , \\ ∀ t ∈ T & 3 \\ {DE\_SLE}_{t} = {\sum }_{{p ∈ P :}_{p . Time = ( t - 1 )}} min l ( p . SLE , ( \begin{matrix}P\_Asset \_Age + p . Time - \\ CurrentYear\end{matrix} ) ) * {V\_AP}_{p} , \\ ∀ t ∈ T & 4 \\ Obj 1 \_SLE = {\sum }_{t ∈ T} {w}_{t} * {DE\_SLE}_{t} & 5 \\ Obj 2 \_BudgetSpending = {\sum }_{p ∈ P} p . Treatment\_Cost * {V\_AP}_{p} & 6 \\ Obj 2 \_BudgetOverage = {\sum }_{t ∈ T} {V\_BudgetOverage}_{t} & 7 \\ Obj 2 \_MaxBudgetOverage \geq {V\_BudgetOverage}_{t} , \\ ∀ t ∈ T & 8 \\ Obj 2 \_AvgAssetAgeExcess = {\sum }_{t ∈ T} {V\_AvgAssetAgeExcess}_{t} & 9 \\ {\sum }_{{p ∈ P :}_{p . Asset\_Id = a}} {V\_AP}_{p} \leq 1 , ∀ a ∈ A & 10 \\ {\sum }_{{p ∈ P :}_{p . Time = t}} p . Treatment\_Cost * {V\_AP}_{p} \leq B . {Budget}_{t} + P\_Obj 2 \_Selected * {V\_BudgetOverage}_{t} , \\ ∀ t ∈ T & 11 \\ {\sum }_{{p ∈ P :}_{{p . Time = bp . Time ,}_{p . Treatment = bp . Treatment}}} p . Treatment\_Cost * {V\_AP}_{p} \leq ( B . {Budget}_{t} + P\_Obj 2 \_Selected * {V\_BudgetOverage}_{t} ) * BP . Percentage , \\ ∀ bp ∈ BP \text{:} bp . Direction = {}_{}^{′}{atMost}{}_{}^{′} & 12 \\ {\sum }_{{p ∈ P :}_{{p . Time = bp . Time ,}_{p . Treatment = bp . Treatment}}} p . Treatment\_Cost * {V\_AP}_{p} \geq ( B . {Budget}_{t} + P\_Obj 2 \_Selected * {V\_BudgetOverage}_{t} ) * BP . Percentage , \\ ∀ bp ∈ BP \text{:} bp . Direction = {}_{}^{′}{atLeast}{}_{}^{′} & 13 \\ {DE\_AvgAssetAge}_{t} - {V\_AvgAssetAgeExcess}_{t} \leq TA . {Target\_Age}_{t} , \\ ∀ t ∈ T , \\ P\_Obj 2 \_Selected = 1 & 14\end{matrix}$$

Equations 1.1-1.5 above contain objective functions of the model. In an embodiment, users may do two type of analysis (e.g., have two set of objectives). The first is to select the best treatment options to maximize the service life extension of assets by a given multi-year budget limitation. The parameter P_Obj1_Selected gets a value of 1 if this objective is selected by the user. Equation (1.1) is used to maximize the service life extension of the assets. The second type of analysis is to achieve a target average asset age/condition, and to figure out how much additional budget is needed per year. The parameter P_Obj2_Selected gets a value of 1 if this objective is selected by the user. Equation (1.2) minimizes the deviation from the target age/condition. Equations 1.3-1.5 are used to minimize the additional budget spending and to keep the excess spending as smooth as possible.

As shown in the model above, constraints 2-9 are used to calculate the decision expressions 2-4 which are dependent decision variables and objective function components 5-9. Constraint 10 guarantees that only one treatment option is selected per asset throughout the planning horizon. Constraint 11 makes sure that the spending for the treatments is within the budget throughout the planning horizon. Note that, if the second objective is selected, then the budget limitation is relaxed with overage variables (V_BudgetOverage). Constraints 12-13 are used to make sure that a certain percentage (minimum or maximum) of the total budget (available plus overage) is spent for certain type of treatment options. These constraints are especially useful when some portion of the budget is planned to be allocated for certain programs, such as road resurfacing program. Constraint 14 is used to achieve target asset age/condition when the second objective is selected. Note that these are designed as soft constraints (minimizing the deviation from the target) to prevent infeasibility (it may not be possible to achieve target age/condition requirements in some cases).

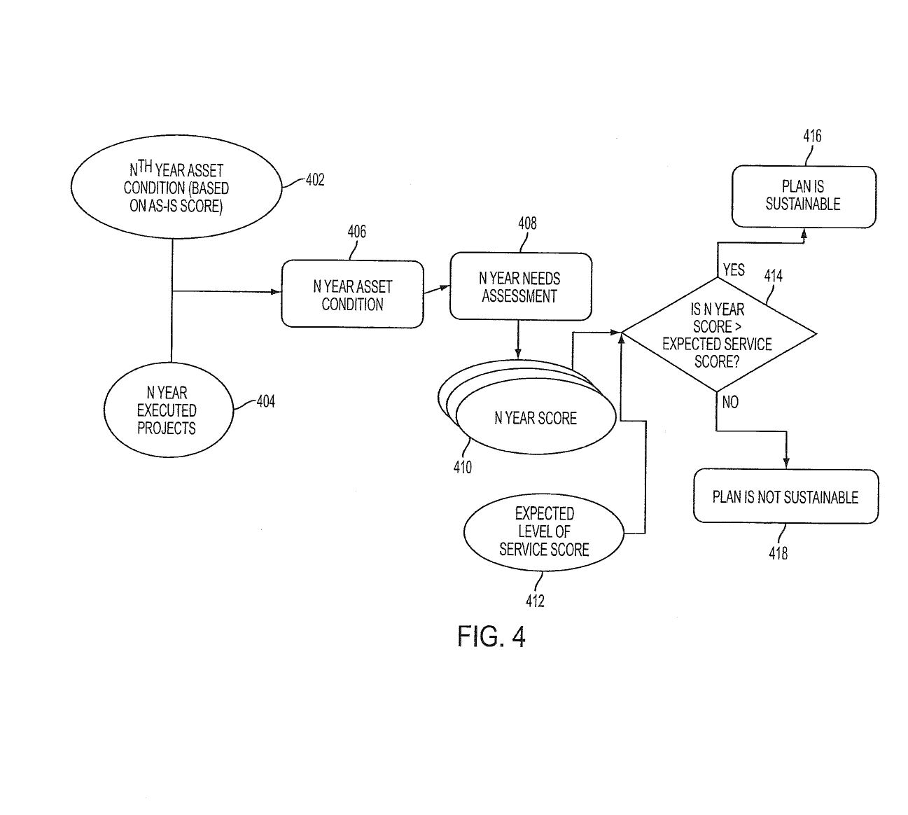

Turning now to FIG. 4, a process for performing a sustainability analysis in accordance with an embodiment is generally shown. FIG. 4 details a step-wise process of performing sustainability analysis. An Nth year condition assessment is shown in block 402. This condition assessment represents the condition of each individual asset (also known as an asset segment) before any prescriptions are applied (e.g., road condition as measured by PQI for the segment may be 5). Executed projects in block 404 are those projects that have been selected for capital investment in the Nth year. Using block 402 and block 404, the system re-calculates the new condition of the asset by applying the impact of the prescription options to the asset segments identified for capital investment. The prescription options allow an improvement in condition for a subset of assets (e.g., applying CIPP relining on the pipes results in an increase in remaining service life by 15 years; repaving the road may change its PQI from 5 to 9). This new condition assessment information is fed to the needs assessment framework. As a result, the system computes the new asset health scores and new prescription options across all assets. The values are computed for the current year and each of the future years in block 408. The score outputs from block 410 define the detailed asset health score values for all asset segments for current and future years.

An expected level of service score in block 412 provides input from an SME into the decision process. The expected level of service score may be defined from the existing service level agreements and these score values may be defined at aggregate levels. N year computed scores in block 410 and expected level of service score in block 412 are fed into block 414 for comparison. When the Nth year score in block 410 is less than the expected level of service score in block 412, then the investment plan (also known as the Nth year executed projects in block 404) are not sufficient to attain sustainability. Otherwise, at block 416, it is determined that the plan is sustainable. Using this, the investment planning agency can revise the Nth year executed project list to attain the right level of sustainability.

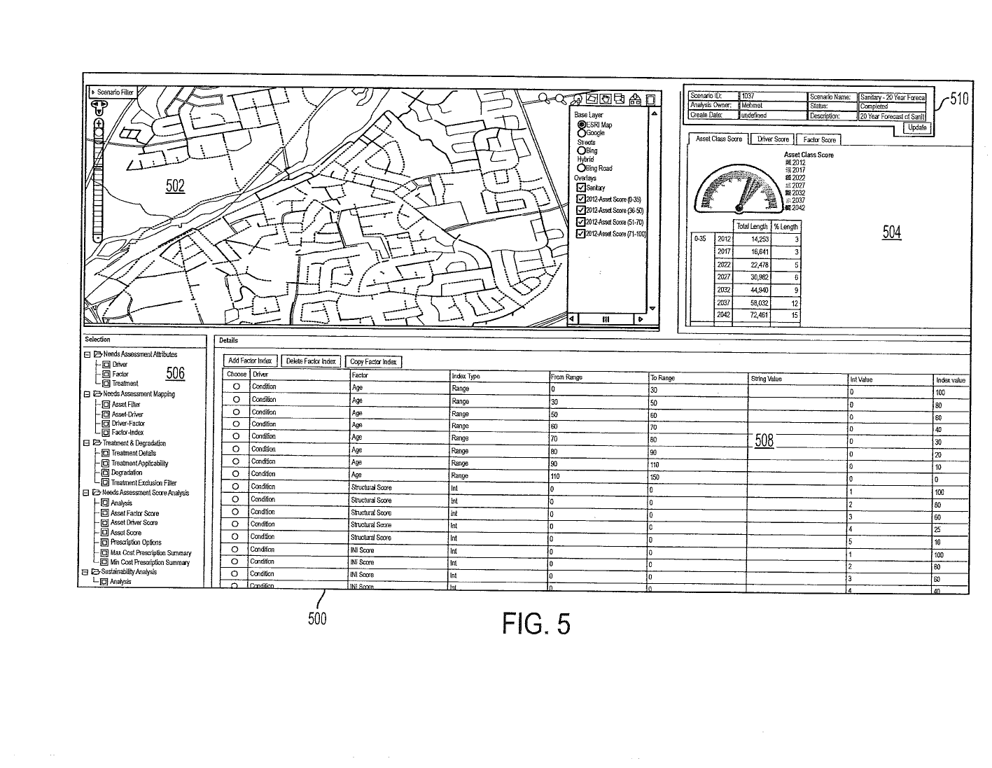

FIG. 5 depicts a user interface 500 of a municipal asset management tool in accordance with an embodiment. The example user interface 500 of FIG. 5 provides a high level needs assessment for a geographic region (e.g., a city) that includes a map view 502, a summary reports view 504, a navigation view 506, a detail display view 508, and a current scenario description view 510. The map view 502 can present asset scores across the geographic region and can color code them based on their scores (e.g., red represents bad health, green represents good health). The map view 502 can present additional map layers showing asset scores that correspond to different assets, time frames, prescription scenarios, budgets, and other scenarios that are calculated as described herein.

The summary reports view 504 presents a high level summary of an asset class score, asset driver score and asset factor score for an asset. As shown in FIG. 5, where the asset class is roadways, depicts, by year, what percentage of the roadways will be at particular score ranges. In addition, an overall class score is shown, by year, for the roadways that may be indicated by color, where a particular color indicates a particular score. Driver scores and factor scores may also be displayed. Selecting (e.g., with a mouse) any of the years or class scores in the table shown in the table shown in FIG. 5 result in displaying additional details for the asset class.

The navigation view 506 can be used to support the entire municipal asset needs and sustainability analysis process, with associated details displayed in the detail display view 508. Clicking on any node or child node in the navigation view 506 can result in corresponding information, such as input data, output data and analysis parameter data (e.g., business drivers, asset factors, budgets, health index or asset score) being displayed in the detail display view 508. In an embodiment, the information displayed by selecting options in the menu in the navigation view 506 includes at least a subset of the data described in reference to FIG. 2.

The current scenario description view 510 can be used to identify information about a current scenario being modeled and displayed.

Selection of Needs Assessment Attributes from the navigation view 506 can be used to provide, via a user interface, details about the business drivers, factors, and treatments in the current scenario. In an embodiment, these details may be viewed and/or modified via the user interface.

Selection of Needs Assessment Mapping from the navigation view 506 can be used to provide, via a user interface, details about mappings between assets and filters, between assets and drivers, between drivers and factors, and between factors and indexes in the current scenario. In an embodiment, these mapping may be viewed and/or modified via the user interface.

Reports or other items provided via the user interface described herein may be presented as any type of graphic (e.g., bar chart, temperature gauge, table, graph, etc.) or as text. In addition, a variety of different colors may be used to designate identified ranges or other data values. In addition, in response to a user request, details behind any summary information be presented to the user Further, a report can include a map with a spatial visualization of an asset health index overlaid on the map to indicate an asset health index (e.g., red is bad health, yellow is average health, green is good health) across a geographic area.

Selection of Treatment and Degradation from the navigation view 506 can be used to view treatment details, treatment applicability, degradation, and treatment exclusion filters. Treatment details describe, for each treatment, a treatment unit, a unit cost, a service life extension, and a service level improvement. Examples of treatments that may be included in a prescription for a road asset include, but are not limited to crack sealing, slurry seal, micro pave, tar and chip, 50 mm overlay, 50 mm grind and resurface, 100 mm grind and resurface, foamed asphalt resurface, pulverize and pave, an full depth and reconstruct. Examples of treatments for water assets include, but are not limited to lining-cement mortar, lining CIPP, lining spray on, replacement. Treatment applicability maps treatment options to assets based on asset driver scores. For example, a treatment of full depth and reconstruct of a road asset may be recommended based on the driver of “condition” when the health index of the road is between 0 and 30, and a treatment of 50 mm grind and resurface may be recommended based on the driver of “condition” when the health index of the road is between 45 and 60. In an embodiment, degradation is a piecewise linear function that defines the cumulative change in the asset factor (e.g., PQI of a road asset as shown in FIG. 1). Degradation is used to calculate asset factor values by time. In an embodiment, a treatment exclusion filter is used to identify treatment options that cannot be applied to assets having specific conditions. In an embodiment, the treatment details, treatment applicability, degradation, and treatment exclusion filters may be viewed and/or modified via the user interface.

Selection of Needs Assessment Score Analysis from the navigation view 506 can provide information about analysis, asset factor score, asset driver score, asset score, prescription options, maximum cost prescription summary, and minimum cost prescription summary. Prescription options can include multi-year prescription options for each asset taking into account the asset degradation by time. For example, for road segments and a driver of “condition”, a prescription option may include crack sealing in the year 2017, which would cost $15,000, provide a service life extension of 2 years, a service quality improvement of zero.

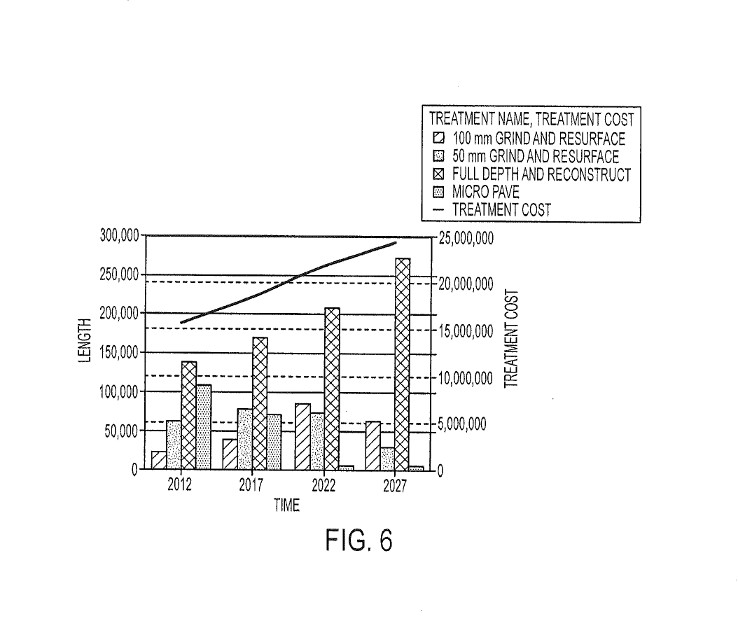

Turning now to FIG. 6, selection of the maximum cost prescription summary and/or the minimum prescription cost summary under the Needs Assessment Score Analysis option on FIG. 5 may result in the chart shown in FIG. 6. The chart shown in FIG. 6 depicts types and costs of treatments by time.

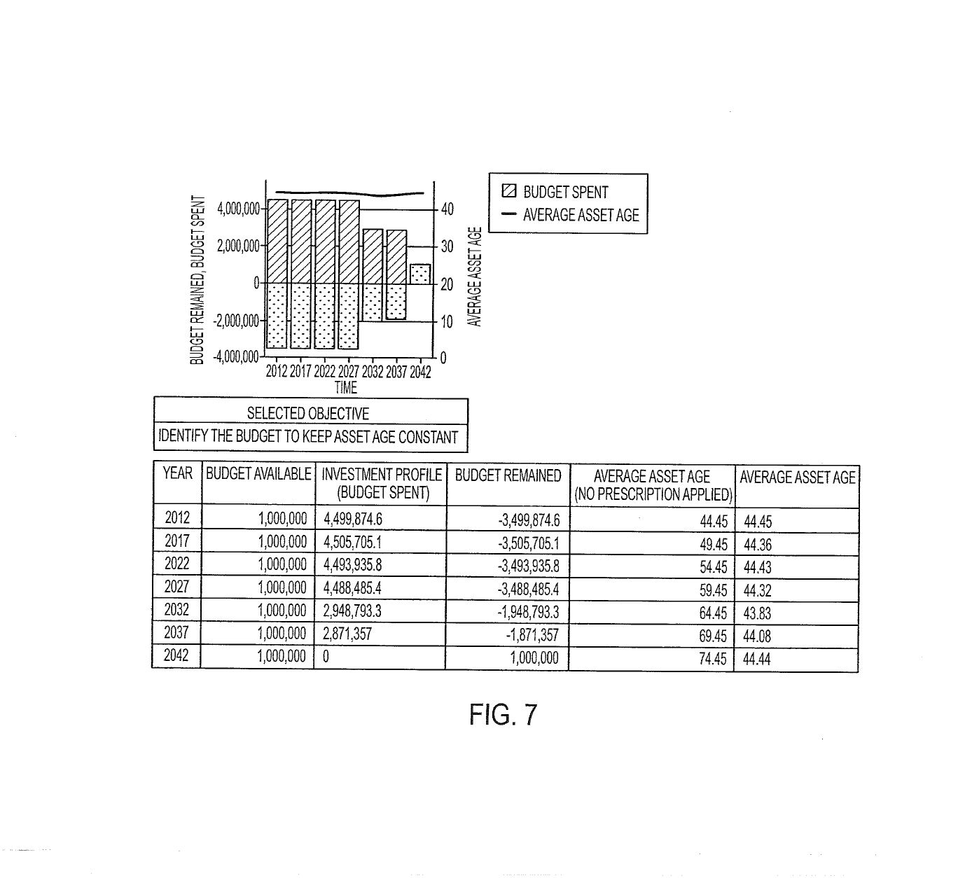

Turning now to FIG. 7, selection of Sustainability Analysis from the navigation view 506 in FIG. 5 can provide a chart, such as that shown in FIG. 7. The chart shown in FIG. 7 depicts sustainability analysis results that analyzed the long term sustainability of assets covering multi-year prescription options (degradation) and available (predicted) budget. FIG. 7 shows, average asset age for a given expected budget. Additional reports may show additional budget money required to achieve certain selected levels of asset health in the long term.

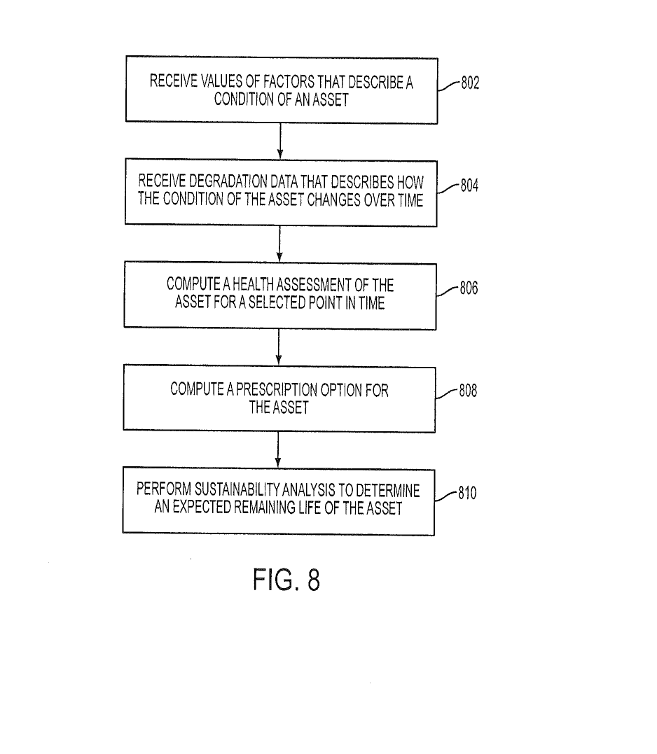

Turning now to FIG. 8, a process flow for performing asset management in accordance with an embodiment is depicted. At block 802, values of factors (e.g., asset factors) that describe a condition of an asset are received (e.g., from a user, from a database). At block 804, degradation data that describes how the condition of the asset changes over time is received (e.g., from a user, from a database). At block 806, a health assessment (or health index) of the asset is computed for a selected point in time (e.g., today, in 5 years, in 10 years). In an embodiment, the health assessment is output at block 806 (e.g., as a report via a user interface). In an embodiment, at block 808, a prescription option for the asset is computed, and at block 810 sustainability analysis is performed to determine an expected remaining life of the asset.

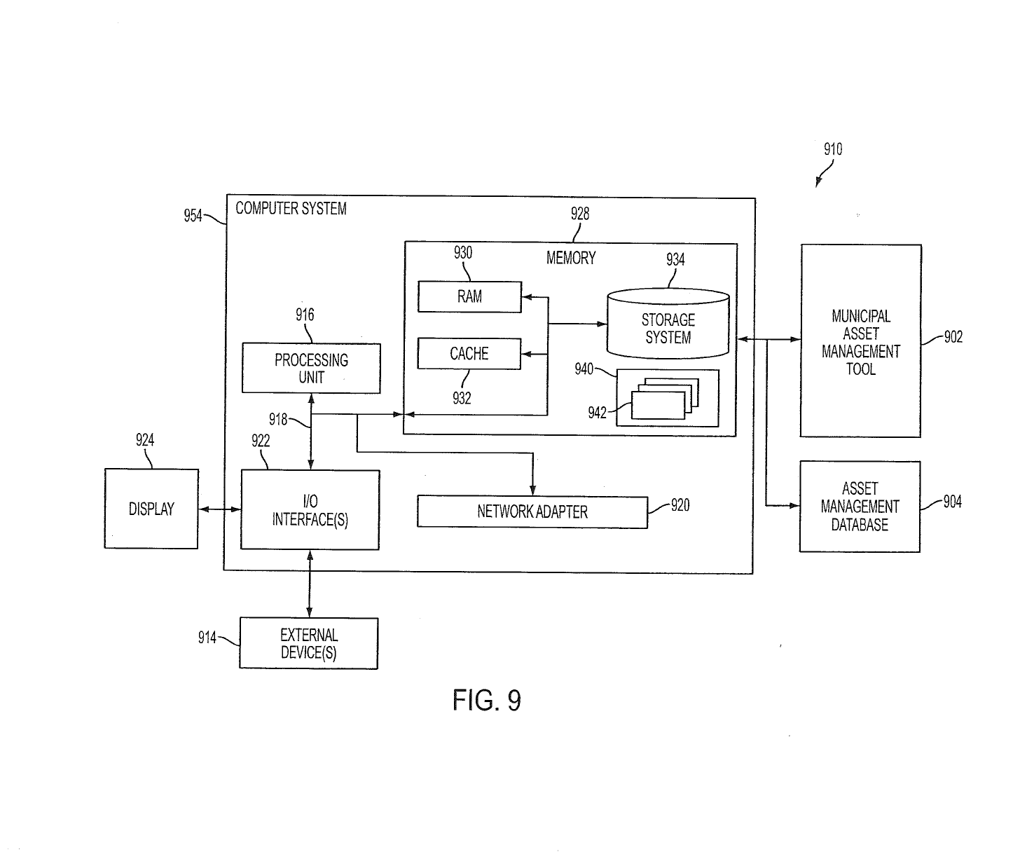

Referring now to FIG. 9, a schematic of an example of a computer system 954 in a network environment 910 is shown. The computer system 954 is only one example of a suitable computer system and is not intended to suggest any limitation as to the scope of use or functionality of embodiments of the invention described herein. Regardless, computer system 954 is capable of being implemented and/or performing any of the functionality set forth hereinabove.

In network environment 910, the computer system 954 is operational with numerous other general purpose or special purpose computing systems or configurations. Examples of well-known computing systems, environments, and/or configurations that may be suitable as embodiments of the computer system 954 include, but are not limited to: personal computer systems, server computer systems, cellular telephones, thin clients, thick clients, hand-held or laptop devices, multiprocessor systems, microprocessor-based systems, set top boxes, programmable consumer electronics, network personal computer (PCs), minicomputer systems, mainframe computer systems, and distributed cloud computing environments that include any of the above systems or devices, and the like.

Computer system 954 may be described in the general context of computer system-executable instructions, such as program modules, being executed by one or more processors of the computer system 954. Generally, program modules may include routines, programs, objects, components, logic, data structures, and so on that perform particular tasks or implement particular abstract data types. Computer system 954 may be practiced in distributed computing environments, such as cloud computing environments, where tasks are performed by remote processing devices that are linked through a communications network. In a distributed computing environment, program modules may be located in both local and remote computer system storage media including memory storage devices.

As shown in FIG. 9, computer system 954 in network environment 910 is shown in the form of a general-purpose computing device. The components of computer system 954 may include, but are not limited to, one or more computer processors or processing units 916, a system memory 928, and a bus 918 that couples various system components including system memory 928 to processor 916.

Bus 918 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 954 typically includes a variety of computer system readable media. Such media may be any available media that is accessible by computer system 954, and it includes both volatile and non-volatile media, removable and non-removable media.

System memory 928 can include computer system readable media in the form of volatile memory, such as random access memory (RAM) 930 and/or cache memory 932. Computer system 954 may further include other removable/non-removable, volatile/non-volatile computer system storage media. By way of example only, storage system 934 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 918 by one or more data media interfaces. As will be further depicted and described below, system memory 928 may include at least one program product having a set (e.g., at least one) of program modules that are configured to carry out the functions of embodiments of the invention.

Program/utility 940, having a set (at least one) of program modules 942, may be stored in system memory 928 by way of example, and not limitation, as well as an operating system, one or more application programs, other program modules, and program data. Each of the operating system, one or more application programs, other program modules, and program data or some combination thereof, may include an implementation of a networking environment. Program modules 942 generally carry out the functions and/or methodologies of embodiments of the invention as described herein. An embodiment of the municipal asset management tool 902 may be stored in system memory 928 and may be implemented within a web browser. The municipal asset management tool 902 may include logic that is configured to generate, access, and update an asset management database 904 for an associated user. Although the municipal asset management tool 902 may be implemented within a web browser, all or portions of the municipal asset management tool 902 can be incorporated in any application or module. The asset management database 904 can be stored in storage system 934 or in other portions of system memory 928. Alternatively, the asset management database 904 may be stored elsewhere in the network environment 910. The asset management database 904 is used herein as one example of a location where the product research data may be stored, it is not intended to imply that a database system is required as the product research data may be stored in any manner that allows types of accesses described herein.

Computer system 954 may also communicate with one or more external devices 914 such as a keyboard, a pointing device, a display device 924, etc.; one or more devices that enable a user to interact with computer system 954; and/or any devices (e.g., network card, modem, etc.) that enable computer system 954 to communicate with one or more other computing devices. Such communication can occur via input/output (I/O) interfaces 922. Still yet, computer system 954 can communicate with one or more networks such as a local area network (LAN), a general wide area network (WAN), and/or a public network (e.g., the Internet) via network adapter 920. As depicted, network adapter 920 communicates with the other components of computer system 954 via bus 918. It should be understood that although not shown, other hardware and/or software components could be used in conjunction with computer system 954. Examples, include, but are not limited to: microcode, device drivers, redundant processing units, external disk drive arrays, redundant array of independent disk (RAID) systems, tape drives, and data archival storage systems, etc.

It is understood in advance that although this disclosure includes a detailed description on a particular computing environment, implementation of the teachings recited herein are not limited to the depicted computing environment. Rather, embodiments are capable of being implemented in conjunction with any other type of computing environment now known or later developed (e.g., any client-server model, cloud-computing model, etc.).

Technical effects and benefits include the ability to use a model to generate health indexes (current and predicted), prescription options, and sustainability analyses for asset groups. Different scenarios may be modeled by varying the input data to allow asset mangers to quickly assess the impacts of different scenarios on asset health and sustainability.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for asset management, the method comprising:
calculating asset health scores for a plurality of assets in an infrastructure, wherein the asset health scores change as a function of time;
identifying prescription options for the assets, the identifying based on the asset health scores, and the prescription options comprising cost, value and time for execution; and
applying multi-objective optimization based on the asset health scores and prescription options to identify at least a subset of the prescription options that may be implemented within a provided budget to maintain a sustainability threshold for an overall infrastructure health score.

2. The computer-implemented method of claim 1, wherein calculating the asset health scores is based on business drivers associated with the assets, factors associated with the business drivers that describe conditions of the assets, and degradation predictions associated with the assets.

3. The computer-implemented method of claim 2, wherein a business driver is assigned a weight to indicate a relative importance of the business driver to an asset health score of an asset, and the weight is input to calculating the asset health scores.

4. The computer-implemented method of claim 2, wherein a factor is assigned a weight to indicate a relative importance of the factor to a business driver, and the weight is input to calculating the asset health scores.

5. The computer-implemented method of claim 1, wherein an output of the applying includes at least one of a predicted change in an expected remaining life of an asset and a predicted change in a quality service level of an asset.

6. The computer-implemented method of claim 1, wherein an output of the applying includes at least one of a predicted qualitative improvement and a predicted quantitative improvement of an asset.

7. The computer-implemented method of claim 1, wherein the multi-objective optimization is further based on a selected point in time and the overall infrastructure health score corresponds to the selected point in time.

8. The computer-implemented method of claim 1, wherein:
the infrastructure is a city infrastructure;
the assets include assets characterized as under ground assets and above ground assets; and
the assets include assets characterized as linear assets and point assets.
